(19) United States
(12) Patent Application Publication
(10) Pub. No.: US 2012/0280836 A1
(43) Pub. Date: Nov. 8, 2012

(54) Vehicle Detection System with RFID-Based Location Determination

(75) Inventor: Bruce B. Roesner, Durham, NC (US)

(73) Assignee: FEDERAL SIGNAL CORPORATION, Oak Brook, IL (US)

(21) Appl. No.: 13/100,997

(22) Filed: May 4, 2011

(51) Int. Cl. G08G 1/14

(52) U.S. Cl. 340/932.2

(57) ABSTRACT

A vehicle detection and location system includes a plurality of RFID tags positioned along a parking array. The system includes an RFID reader movable in conjunction with a vehicle identification system along the parking array and configured to interrogate the RFID tags. A location of the vehicle can be determined based on an association of the interrogation by the RFID reader with an identifier detected by the vehicle identification system.

### BACKGROUND

Increasingly, camera systems are employed to recognize vehicles, for example for purposes of parking or traffic enforcement, or to identify cars registered to individuals of interest. Various types of camera systems can be employed. For example, in some cases, camera systems can be positioned on a moving vehicle to identify vehicles, for example for purposes of enforcing on-street parking regulations, or for identifying vehicles of interest (e.g., stolen vehicles or other vehicles reported to a public authority). Existing systems located on moving vehicles typically use cameras employing optical character recognition (OCR) or license-plate recognition (LPR) technologies to identify and monitor parked cars on a street or in a garage.

Beyond simply recognizing the vehicle whose image is captured by the camera, it is often desirable, particular in the context of parking enforcement, to know the location of the vehicle. For example, it may be illegal to park on a particular side of the street in a particular area (e.g., a city block), or within a particular zone or portion of a block. Existing systems attempt to use geographic positioning systems (GPS) in association with a camera system using OCR or LPR technologies to associate geographic position of a camera with an identity of a vehicle. However, this approach has reliability issues, particularly in metropolitan areas. This is because GPS systems may have inaccurate positional information due to a “canyon effect” in which an RF signal reflects off of buildings, causing GPS readings to become unreliable. For example, a GPS reading could indicate a location one or more blocks away from an actual location of the GPS receiver. In systems where parking or vehicle enforcement rules may vary from block to block, this variability in GPS readings renders the location determination from such systems unreliable. This problem is exacerbated by the increased parking density typically found in such metropolitan areas.

For these and other reasons, improvements are desirable.

### SUMMARY

In accordance with the following disclosure, the above and other issues are addressed by the following:

In one aspect, a vehicle detection and location system includes a plurality of RFID tags positioned at known locations along a vehicle array. The vehicle detection and location system also includes an RFID reader associated with and movable in conjunction with a vehicle identification system along the parking array, the RFID reader configured to interrogate one or more of the plurality of RFID tags in a vicinity of the RFID reader. The vehicle detection and location system further includes a processing unit configured to determine a location of a vehicle identified by the vehicle identification system along the vehicle array based on the relative position of the RFID reader and the one or more of the plurality of RFID tags.

In another aspect, a method of detecting a location and identity of a vehicle occurs while simultaneously moving a vehicle identification system and associated RFID reader along an array of vehicles. The method includes detecting an identifier of a vehicle positioned within the array of vehicles using the vehicle identification system, and interrogating one or more of a plurality of RFID tags with the RFID reader, the plurality of RFID tags placed at known locations along the array of vehicles. The method further includes determining a location of the vehicle along the array of vehicles based on the relative position of the RFID reader and the one or more of the plurality of RFID tags.

In yet another aspect, a parking violation detection system includes a plurality of RFID tags positioned at known locations along a parking lane, the plurality of RFID tags including one or more RFID tags mounted above the parking lane and at a street corner. The parking violation detection system also includes a camera system mounted to a parking enforcement vehicle and configured to detect an identifier of a vehicle positioned along the parking lane. The parking violation detection system further includes an RFID reader mounted to the vehicle in proximity to the camera system, the RFID reader configured to interrogate one or more of the plurality of RFID tags in proximity to the vehicle. The parking violation detection system includes a processing unit configured to determine a location of the vehicle along the parking array based on the relative position of the RFID reader and the one or more of the plurality of RFID tags and associate the location of the vehicle with the identifier of the vehicle.

### BRIEF DESCRIPTION OF THE DRAWINGS

FIG. 1 is a schematic view of a vehicle detection and location system, according to a possible embodiment of the present disclosure;

FIG. 2 is a schematic view of a vehicle detection and location system according to a further possible embodiment of the present disclosure;

FIG. 3 is a schematic block diagram of a portion of a vehicle detection and location system, according to a possible embodiment of the present disclosure;

FIG. 4 is a schematic view of a violation detection system capable of incorporating a vehicle detection and location system such as those disclosed in FIGS. 1-2;

FIG. 5 is a schematic view of an alternative violation detection system capable of incorporating a vehicle detection and location system such as those disclosed in FIGS. 1-2; and

FIG. 6 is a flowchart of methods and systems for detecting a location and identity of a vehicle.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure. Additionally, any examples set forth in this specification are not intended to be limiting and merely set forth some of the many possible embodiments for the present disclosure.

In general, the present disclosure relates to detecting a location and identity of a vehicle, and associating the identity of the vehicle with a location using an RFID-based location determination system. In various embodiments disclosed herein, a movable vehicle detection and location system is disclosed that captures an identifier, such as a license plate number, of a vehicle. By correlating that identifier with a location determined by an RFID reader that interrogates RFID tags placed in the vicinity of the vehicle, the vehicle's identity and location can be accurately determined, for example for determining the existence of a parking violation or other type of violation.

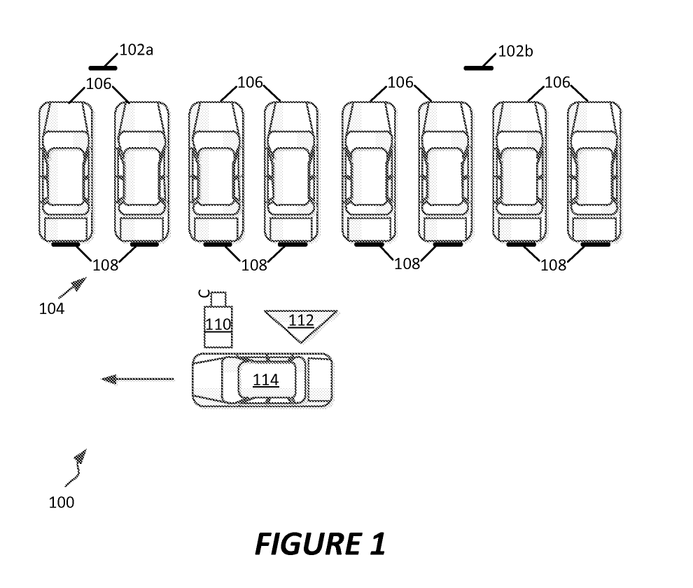

Referring now to FIG. 1, a schematic view of a vehicle detection and location system 100 is shown according to a possible embodiment of the present disclosure. The system 100 includes a plurality of RFID tags 102 positioned at known locations along a vehicle array 104. In the embodiment shown, two RFID tags 102a-b are shown; however, in various embodiments of the present disclosure, additional RFID tags could be used as well. The vehicle array 104 is an arrangement of vehicles 106 that can be positioned in a line or other order, for example in a street parking arrangement, in a parking ramp, or as a lane of moving traffic. In the embodiment shown, each vehicle 106 has an associated identifier 108. The associated identifier 108 can be any type of unique identifier associated with the vehicle, with which the vehicle owner and vehicle itself can be identified. In some embodiments, the identifier 108 is a license plate or other readily-viewable identification mark. In other embodiments, the identifier 108 is an RFID tag uniquely associated with the vehicle. In the embodiment shown, the identifier 108 is illustrated as being positioned on one side of each vehicle; however, in many arrangements, more than one identifier can be used, and identifiers can be placed on opposite sides of the vehicle 106 (e.g., a front and rear of the vehicle).

In the embodiment shown, the system 100 further includes a vehicle identification system, shown as camera 110. The system also includes an RFID reader 112. In the embodiment shown, the camera 110 and RFID reader 112 are placed in close association with each other, and movable along the vehicle array 104. In the embodiment shown, the camera 110 and RFID reader 112 are mounted to an enforcement vehicle 114. The enforcement vehicle 114 can be, in various embodiments, a parking enforcement vehicle or a police vehicle. Other enforcement vehicles or movement arrangements may be possible as well.

The camera 110 captures images of vehicles and identifies those vehicles based on visible characteristics of the vehicle. In certain embodiments, the camera 110 captures images of vehicles that include an image of an identifier, such as a license plate, on that vehicle, and can then use optical character recognition (OCR) or license-plate recognition (LPR) technologies to identify the vehicle. Identifying the vehicle can include, for example, cross-referencing a captured license plate number against a database of license plate numbers and associated owners of the vehicle. Using this information, any violations apparent relating to the vehicle (e.g., parking violations, moving violations, expired registrations, etc.) or reported incidents (e.g., a stolen or missing vehicle) can be quickly associated with a particular vehicle and a particular owner. In certain embodiments, the camera 110 implements the Automated License Plate Recognition systems of PIPS Technology Knoxville, Tenn. Other camera-based vehicle identification systems could be used as well.

The RFID reader 112 generally is configured to interrogate the RFID tags 102. Depending upon the particular RFID tags that respond to the interrogation by the RFID reader, and optionally the strength of response signal from the RFID tags 102, the RFID reader 112 can determine a current location relative to the RFID tags. Since the RFID tags 102 are placed at known locations, the location of the RFID reader 112 (and consequently the camera 110) can be determined. For example, if the RFID reader 112 transmits an interrogation signal and receives a response from tag 102a but not from tag 102b, it can be assumed that the RFID reader 112 is within range of the RFID tag 102a but not RFID tag 102b. Alternatively, the RFID reader 112 can use any of a number of available triangulation algorithms to determine a more precise location based on a measurement of relative signal strength of responses from tags 102a-b to place the RFID reader at a computable distance from each of tags 102a-b. Additionally, in cases where tags are placed at sufficiently close distances, relative response strengths of three or more tags could be compared and calculated. Other methods of locating the RFID reader 112 (and consequently the vehicles 106) are possible as well.

In certain embodiments, the RFID reader 112 can be any of a number of RFID reader devices, such as the IDentity™ 4100 UHF Reader manufactured by Federal Signal Technologies of Irvine, Calif. Other RFID readers can be used as well. In conjunction with this RFID reader, the RFID tags 102 can be either active or passive RFID tags. In some examples, the tags are passive IDentity MaX Pro Transponders manufactured by Federal Signal Technologies of Irvine, Calif. Other types of RFID readers and RFID tags could be used as well, consistent with the principles of the present disclosure.

In embodiments where the identifier 108 is an RFID tag, an RFID reader is used to identify the vehicles 106. In such embodiments, the camera 110 can either be used in conjunction with the RFID reader or be eliminated completely from the system 100. The RFID reader used to identify vehicles 106 can be the RFID reader 112, or a second RFID reader dedicated to identifying vehicles based on RFID tags.

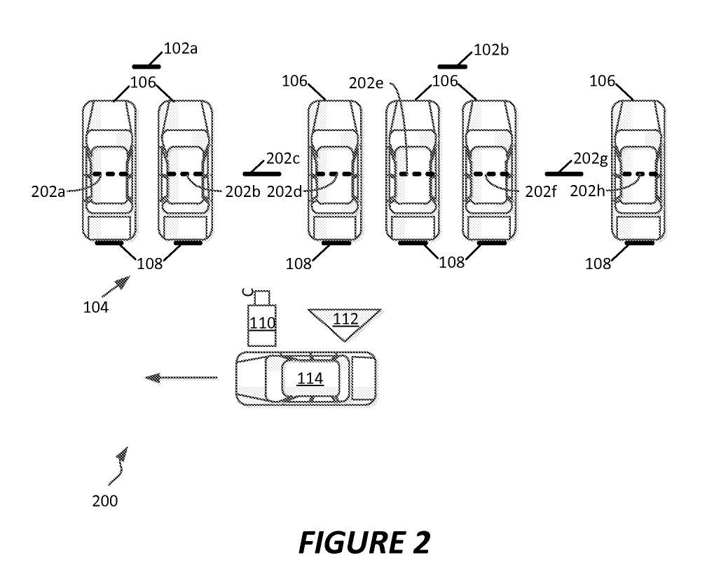

FIG. 2 is a schematic view of a vehicle detection and location system 200 according to a further possible embodiment of the present disclosure. In this embodiment, the system 200 also includes a plurality of RFID tags 102 positioned at known locations along a vehicle array 104, as well as a movable combination of a camera 110 and RFID reader 112. However, in this embodiment, an additional set of RFID tags 202 are positioned at second known locations along the vehicle array. In the embodiment shown, the RFID tags 202 (shown as RFID tags 202a-h) are positioned in the vehicle array 106, at known locations in which vehicles are likely to reside (e.g., defined parking spaces). The RFID tags 202 can be, in some embodiments, embedded within pavement of parking spaces along the vehicle array 106.

In operation, the vehicle detection and location system 200 operates generally in an analogous manner to that described above with respect to FIG. 1; however, in this arrangement, interrogation by the RFID reader 112 will return responses from one or more of the RFID tags 102 as well as one or more RFID tags 202. In this arrangement, a generalized location of the RFID reader 112 can be determined from responses of either or both sets of RFID tags. Additionally, based on the known location of the RFID reader 112, if one or more RFID tags 202 are positioned in a vicinity of the RFID reader 112 but have not responded to an interrogation, it can be assumed that a radio-frequency path between the RFID tags 202 and reader 112 is blocked by a vehicle located over the RFID tag (e.g., parked in the parking space associated with that RFID tag 202). In the example illustrated, RFID reader 112 may interrogate tags 102, 202 in the position shown. Based on an interrogation response from one or both RFID tags 102a-b and tags 202c, 202g, it can be assumed that, if the other tags 202a-b, 202d-f, 202h return no response, that there are vehicles 106 present in the parking spaces associated with those tags. By repeatedly interrogating tags 102, 202 as the RFID reader 112 and camera 110 travel along the vehicle array 104, it can be assumed that each of the RFID tags 202 will be within range of the RFID reader; therefore, if no response is ever returned from a particular RFID tag, that repeated non-response can further validate that a vehicle is present in the parking space.

As with the arrangement illustrated in FIG. 1, vehicles can also be identified by use of a unique RFID tag associated with that vehicle as the identifier 108. In such embodiments, reading such an RFID tag without reading an associated tag 202 would indicate that the vehicle identified by the RFID tag identifier is in a particular known location within the vehicle array.

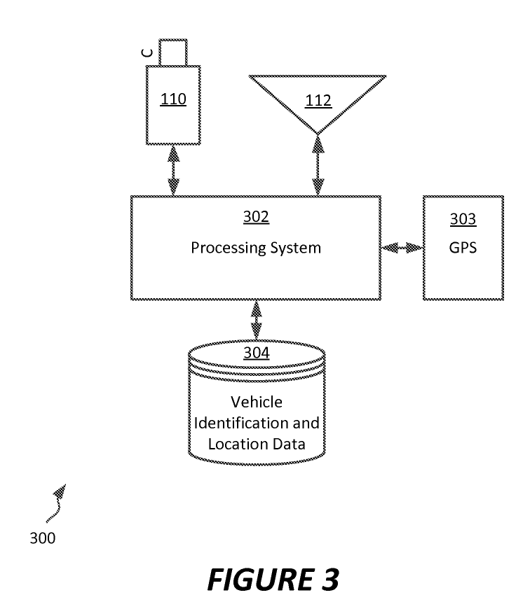

Referring now to FIG. 3, a schematic block diagram of a portion of a vehicle detection and location system 300 is shown, according to a possible embodiment of the present disclosure. The portion of the system 300 shown generally corresponds to the components of a system at least partially movable along a vehicle array, such as in an enforcement vehicle 114 as shown in FIGS. 1-2.

The system 300 includes the camera 110 and RFID reader 112, as discussed above. The camera 110 and RFID reader 112 are each communicatively connected to a processing system 302. The processing system 302 can generally be a portable computing system configured to receive information captured by the camera 110 and RFID reader 112, including the vehicle identifier information (e.g., images or captured alphanumeric information extracted from captured images), and location information, such as information from the RFID reader 112 regarding detected RFID tags 102, 202. In some embodiments, the processing system 302 can be integrated, in part or whole, into one or both of the camera 110 or the RFID reader 112; in such cases, the camera 110 and RFID reader 112 are directly communicatively connected to each other, for data transfer therebetween (e.g., exchanging records relating to vehicle identities, location, or other relevant vehicle information).

In one possible embodiment, the RFID reader 112 is used in conjunction with a global positioning unit (GPS) 303 to determine a general location of the RFID reader 112. For example, the GPS 303 could provide information about the particular block or neighborhood in which the RFID reader 112 is located, and the RFID reader could then further refine that location information based on responses from the RFID tags 102.

The processing system 302 includes a vehicle and location data collection 304. The vehicle and location data collection 304 can include, for example, a database of registered vehicles and owner information; a collection of reported stolen automobiles; a collection of rules relating to legal and illegal parking spaces, and a database of information relating to the known locations of RFID tags 102, 202. Other information can be included in the vehicle data collection 304 as well.

In use, the processing system 302 compiles the vehicle identity and location information to generate correlated records indicating the location and identity of a single vehicle. This information can then be used, for example, to track vehicles or to determine the existence of one or more types of moving or parking violations attributable to the vehicle.

In certain embodiments, one or more portions of the vehicle and location data collection 304 are located remotely from the processing system 302 and enforcement vehicle 114. This may be the case, for example, where a wireless or other type of communicative connection exists between the processing system 302 and a remote system maintaining the vehicle and location data collection 304, for example at a main office or other data collection location.

Referring to FIGS. 1-3 generally, while in prior art systems location-based technologies have limited reliability, when vehicle identities determined by camera 110 are combined with location information determined by the RFID reader 112, a number of advantageous effects occur. For example, when a vehicle 106 is identified as committing a violation is observed, its location can be associated with that vehicle, to automatically associate additional information associated with the violation with that vehicle. For example, parking or law enforcement personnel could indicate that a particular vehicle is committing a violation, and can generate a record in a database relating to that violation that includes a location at which the violation occurred (as determined by the RFID reader 112). Alternatively, the combined arrangement of the camera 110 and the RFID reader 112 can itself automatically determine that a potential violation has occurred. This could be, for example, if a vehicle 106 is parked at a location where no parking is allowed. Particularly in this arrangement, prior art systems lacking accurate location determinations are deficient.

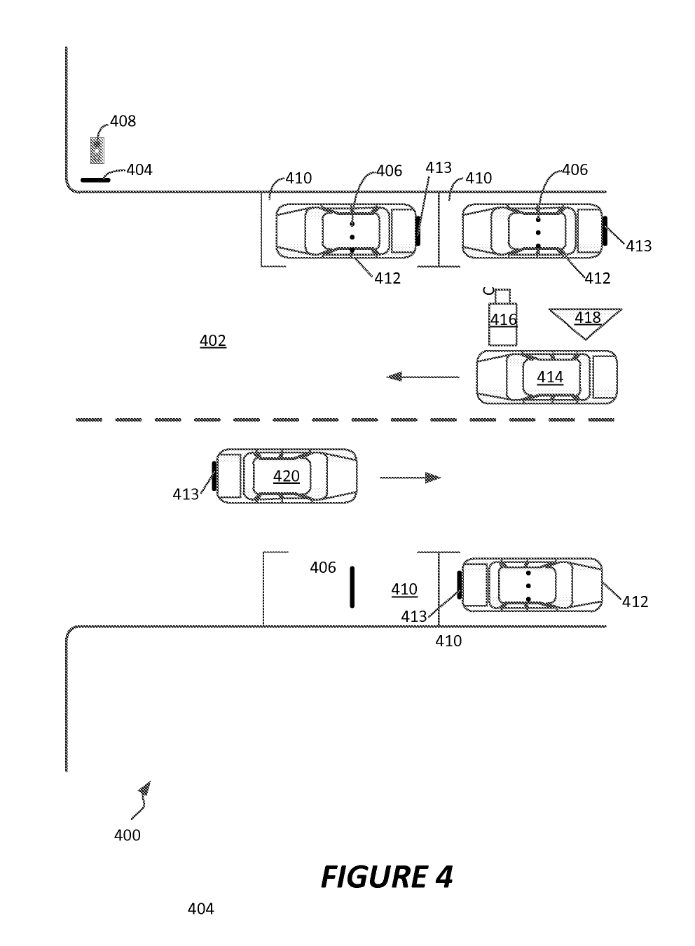

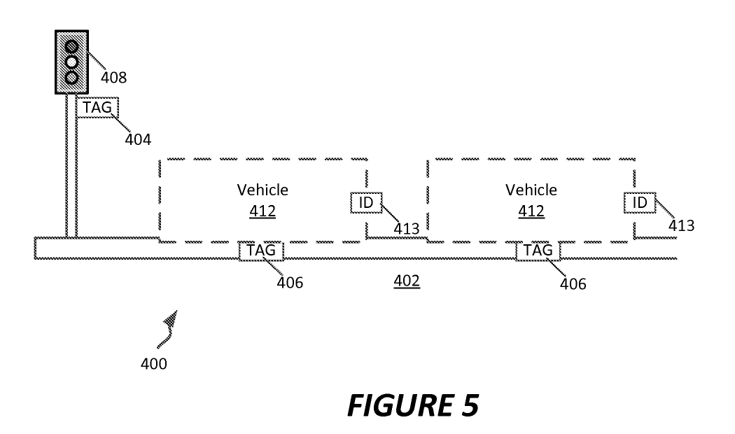

Referring now to FIGS. 4-5, schematic views of a violation detection system 400 are shown, according to a possible embodiment of the present disclosure. The violation detection system 400 can, in certain embodiments, include a vehicle detection and location system, such as the systems described above in conjunction with FIGS. 1-3.

FIG. 4-5 show schematic views of a violation detection system 400 capable of incorporating a vehicle detection and location system such as those disclosed in FIGS. 1-2. In the embodiment shown, the violation detection system 400 is positioned along a street 402, for example a city block or other area where vehicle parking may take place. The violation detection system 400 includes one or more first RFID tags 404 and second RFID tags 406. In the embodiment shown, the first RFID tags 404 are located at elevated, known locations along the street 402 (for example, mounted to a traffic light post 408 as shown). Although in this particular example only one RFID tag 402 is shown, it is recognized that typical arrangements will include more than one such RFID tag.

In the embodiment shown, the second RFID tags 406 are placed in parking spaces 410, for example mounted within the pavement of the street 402. The second RFID tags 406 are located such that parked vehicles 412 in the parking spaces 410 will be located above the corresponding RFID tag associated with that parking space 410.

Additionally, in the embodiment shown, an enforcement vehicle 414 includes a camera 416 and an RFID reader 418, which generally correspond to the camera 410 and RFID reader 112 of FIGS. 1-3, above. Images of parked vehicles 412, and associated identifiers 413, can be captured by the camera 410 (or optionally an RFID reader), while RFID tags 404, 406 can be interrogated by RFID reader 418. In this embodiment, the enforcement vehicle 414 can be configured to detect and process violations by the parked vehicles 412, and associate location information with those vehicles. Additionally, the enforcement vehicle 414 can also receive information regarding location and identity of moving vehicles (e.g., vehicle 420, having vehicle identifier 413), to associate that information with the vehicle for observed violations, or to detect a vehicle associated with potential preexisting violations (e.g., a stolen or unregistered vehicle, or a vehicle associated with an individual of interest to law enforcement).

Although in the embodiment shown the camera 416 and RFID reader 418 are oriented toward a side of the street 402 to allow it to focus on parked vehicles 412 in parking spaces 410, it is recognized that the orientation of the camera 416 and RFID reader 418 is a matter of choice. Additionally, two or more cameras could be associated with a particular RFID reader, for example to capture images from cameras oriented in different directions; additionally, multiple RFID readers could be used as well.

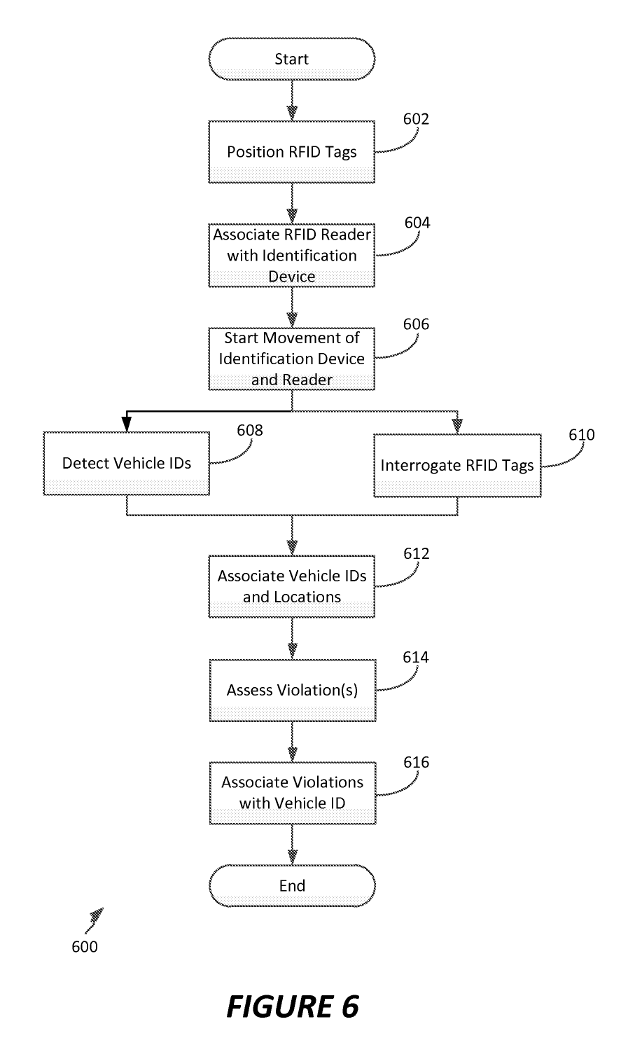

Referring now to FIG. 6, a flowchart of an example method 600 for detecting a location and identity of a vehicle is shown according to a possible embodiment of the present disclosure. The method 600 starts by positioning RFID tags 102, 202 (step 602) at known locations along a vehicle array, such as in any of the variety of RFID tag arrangements disclosed above in connection with FIGS. 1-2 and 4-5. This can optionally include mounting or embedding the RFID tags 202 in a paved area of parking spaces on a street or in a ramp, or mounting tags 102 at elevated locations along a vehicle array (e.g., in a ramp or along a street, such as at a street corner).

A vehicle identification system, such as cameras 110, 416 of FIGS. 1-5 above, is associated with an RFID reader, such as RFID readers 112, 418 (step 604). In various embodiments, this includes mounting a camera and RFID reader on an enforcement vehicle, such that both the camera and RFID reader are movable relative to an array of vehicles (e.g., parked vehicles), but fixed in position or location relative to each other.

To initiate detection of location and identity of vehicles, movement of the vehicle identification system and RFID reader is initiated (step 606), such that the vehicle identification system and RFID reader pass along the vehicle array. This can occur in any of a number of manners. For example, in some embodiments, movement of a camera and associated RFID reader occurs when an enforcement vehicle begins traveling along a vehicle array, such as array 104 of FIGS. 1-2. In other embodiments, the camera or other vehicle identification system and RFID reader can be mounted to any other type of common, movable structure.

After movement of the vehicle identification system and RFID reader is initiated in step 606, the vehicle identification system is activated to detect vehicle identifiers (step 608). This can be accomplished, for example, by capturing images of each vehicle identifier with a camera system, and detecting vehicle identifiers (e.g., license plates) in images captured by the camera system. Alternatively, this can be accomplished by interrogating RFID tags uniquely associated with vehicles, thereby identifying the vehicle based on the identity of the responding RFID tags. Simultaneously, the RFID reader will transmit interrogation signals and receive responses from RFID tags located along the parking array and in proximity to the RFID reader, as described above.

In certain embodiments, steps 608-610 occur repeatedly, allowing each identified vehicle to have an associated location determined based on interrogations/responses from the RFID reader. In some embodiments, the frequency with which the camera or RFID reader captures images or interrogates vehicle-specific RFID tags differs from the frequency in which the RFID reader interrogates RFID tags placed along the vehicle array and in proximity to the reader and vehicle identification system. In some further embodiments, these actions are synchronized, for example with the RFID reader and camera capturing image and location information in synchronization with each other, such that each camera image captured includes a predetermined number of (e.g., one or more) RFID reader location determinations, or vice versa.

Once each vehicle identifier and related location information are captured, the vehicle identifier and location are interrelated (step 612). This can occur in any of a number of manners. In some embodiments, vehicle identifier information is passed from the camera to a processing system, and location information is passed from the RFID reader to the processing system. The processing system can then, using a database of known RFID tag locations, calculate a current location of the RFID reader based on the presence (or absence) of responses from one or more tags, and can determine a particular location of a vehicle relative to that RFID reader (e.g., based on a known orientation of the camera relative to the location of the RFID reader, or based on the presence or absence of responses from RFID tags associated with particular parking spaces, such as RFID tags 202 in FIG. 2. In some embodiments, to correlate location and vehicle identifier information, time stamps can be captured alongside the image and location information from the camera and RFID reader, respectively, to associate a camera with a corresponding RFID reader location. In still other embodiments, vehicle-specific RFID tag interrogation responses are combined with interrogation responses from RFID tags placed at known positions along a vehicle array, thereby allowing vehicle identities and locations to be combined and interrelated. Other methodologies for interrelating data can be used as well.

Once a vehicle's identity and location are determined, that information can be used to determine the existence of or assign one or more violations to that vehicle. In some embodiments, the processing system can determine whether a violation is occurring (step 614). This can be, for example, based on the fact that a vehicle is parked in a particular location at a particular time (e.g., an area that is a no-parking zone during particular times of day, or other areas where parking is restricted). Other methods for assessing violations can be incorporated into such a system as well.

Additionally, one or more violations can be associated with the particular vehicle identified and located (step 616). This can be performed automatically (e.g., upon confirmation of the existence of a violation determined during step 614) or manually by violation enforcement personnel.

Although steps 614-616 are illustrated herein as occurring in a particular order, it is recognized that, in certain embodiments, determination of the existence of violations occurring based on vehicle identifiers and locations could occur in a different order from that illustrated. Furthermore, steps 614-616 are entirely optional, and need not be present within various embodiments. For example, systems can be implemented which simply record a history of vehicle locations and identities, for example to track usage of parking spaces, streets, or other traffic or parking patterns. Additional operations may also be incorporated into the method 600 shown in FIG. 6, consistent with the present disclosure.

Referring now to FIGS. 1-6 generally, using the vehicle detection and location systems of the present disclosure including RFID readers and RFID tags allows for increased detail and lower error rates in locating and identifying vehicles in a vehicle array, for example as compared to GPS-based location systems. Other advantages of the systems of the present disclosure exist as well. Furthermore, although in the various embodiments disclosed herein the vehicle location and identification systems are described as used in the context of a street parking and traffic arrangement, it is recognized that other applications may exist as well, and are contemplated by the various embodiments disclosed herein. For example, the present disclosure is applicable to location and identification of vehicles within a parking ramp or parking lot, as well as at a toll plaza or other location where vehicle tracking and identification may be desirable.

Generally, consistent with embodiments of the disclosure, the cameras 110, 416, RFID readers 112, 418, and processing systems 302 of the present disclosure can include one or more programmable circuits capable of executing program modules. Program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of example embodiments of the present disclosure. Many embodiments of the disclosure can be made without departing from the spirit and scope of the disclosure.

1. A vehicle detection and location system comprising:
a plurality of RFID tags positioned at known locations along a vehicle array;
an RFID reader associated with and movable in conjunction with a vehicle identification system along the vehicle array, the RFID reader configured to interrogate one or more of the plurality of RFID tags in a vicinity of the RFID reader; and
a processing unit configured to determine a location of a vehicle identified by the vehicle identification system along the parking array based on the relative position of the RFID reader and the one or more of the plurality of RFID tags.

2. The system of claim 1, wherein the processing unit is further configured to associate the location of the vehicle with the identifier of the vehicle.

3. The system of claim 1, further comprising a camera movable along the parking array, the camera system configured to detect an identifier of a vehicle positioned along the vehicle array.

4. The system of claim 3, wherein the camera acts as the vehicle identification system.

5. The system of claim 3, wherein the identifier is a license plate associated with the vehicle.

6. The system of claim 3, wherein the RFID reader and camera are mounted to a vehicle.

7. The system of claim 3, wherein the camera uses optical character recognition to detect a license plate number associated with the vehicle.

8. The system of claim 1, wherein the RFID reader periodically interrogates the one or more RFID tags.

9. The system of claim 1, wherein the one or more RFID tags are mounted at predetermined locations along a street.

10. The system of claim 9, wherein the predetermined locations along a street include one or more positions at a street corner.

11. The system of claim 1, wherein the vehicle array comprises parking locations along a street.

12. The system of claim 1 wherein one or more of the plurality of RFID tags are positioned within one or more parking locations of the vehicle array.

13. The system of claim 12, wherein the processing unit is further configured to determine the presence of a vehicle within the one or more parking locations based on responses received by the RFID reader from the one or more of the plurality of RFID tags.

14. The system of claim 1, wherein one or more of the plurality of RFID tags are positioned at elevated locations above the vehicle array.

15. The system of claim 1, wherein the processing unit is integrated into the RFID reader.

16. The system of claim 1, wherein the vehicle array comprises a traffic lane.

17. The system of claim 1, wherein the vehicle identification system comprises an RFID reader.

18. The system of claim 1, further comprising a GPS unit communicatively connected to the processing unit and configured to determine a general location of the RFID reader.

19. A method of detecting a location and identity of a vehicle, the method comprising:
while simultaneously moving a vehicle identification system and associated RFID reader along an array of vehicles:
detecting an identifier of a vehicle positioned within the array of vehicles using the camera; and
interrogating one or more of a plurality of RFID tags with the RFID reader, the plurality of RFID tags placed at known locations along the array of vehicles; and
determining a location of the vehicle along the array of vehicles based on the relative position of the RFID reader and the one or more of the plurality of RFID tags.

20. The method of claim 19, further comprising associating the location of the vehicle with the identifier of the vehicle.

21. The method of claim 19, further comprising placing a plurality of RFID tags at known locations along the array of vehicles.

22. The method of claim 19, wherein the array of vehicles comprises a parking lane along a street, the method further comprising placing a plurality of RFID tags at known locations including one or more positions at a street corner.

23. The method of claim 19, further comprising associating one or more parking violations with the location of the vehicle and the identifier of the vehicle.

24. The method of claim 19, further comprising determining the existence of a traffic violation based on the identifier of the vehicle.

25. A parking violation detection system comprising:
a plurality of RFID tags positioned at known locations along a parking lane, the plurality of RFID tags including one or more RFID tags mounted above the parking lane and at a street corner;
a camera system mounted to a parking enforcement vehicle and configured to detect an identifier of a vehicle positioned along the parking lane;
an RFID reader mounted to the vehicle in proximity to the camera system, the RFID reader configured to interrogate one or more of the plurality of RFID tags in proximity to the vehicle; and
a processing unit configured to determine a location of the vehicle along the parking array based on the relative position of the RFID reader and the one or more of the plurality of RFID tags and associate the location of the vehicle with the identifier of the vehicle.

26. The parking violation detection system of claim 25, wherein the identifier of the vehicle is a license plate of the vehicle.
